(19) United States
(12) Patent Application Publication
(10) Pub. No.: US 2015/0056418 A1
(43) Pub. Date: Feb. 26, 2015

(54) Foam Laminate

(71) Applicant: TZONG IN YEH, FREMONT, CA (US)

(72) Inventor: TZONG IN YEH, FREMONT, CA (US)

(21) Appl. No.: 14/530,213

(22) Filed: Oct. 31, 2014

Related U.S. Application Data
(63) Continuation-in-part of application No. 13/313,507, filed on Dec. 7, 2011.

(30) Foreign Application Priority Data
Jan. 27, 2011 (TW) 100103158
Aug. 10, 2011 (TW) 100128451

(51) Int. Cl. B32B 5/22; B32B 27/36; B32B 27/32; B32B 27/06; B32B 27/08

(52) U.S. Cl. CPC B32B 5/22; B32B 27/065; B32B 27/08; B32B 27/32; B32B 27/365; B32B 2250/03; B32B 2250/05; B32B 2255/102; B32B 2255/26; B32B 2266/025; B32B 2266/0264; B32B 2305/022; B32B 2323/04; B32B 2323/10; B32B 2307/72
USPC 428/189; 428/316.6; 428/215

(57) ABSTRACT

A foam laminate material includes a non-foaming plastic sheet and two foam layers. A lower surface of the first foam layer is directly bonded to an upper surface of the non-foaming plastic sheet, an upper surface of the second foam layer is directly bonded to a lower surface of the non-foaming plastic sheet. Alternatively, the first foam layer and the non-foaming plastic sheet also are able to be bonded by a first binding layer; the second foam layer and the non-foaming plastic are able to be bonded by a second binding layer.

### BACKGROUND OF INVENTION

1. Field of Invention

The present invention relates to a foam laminate and, more particularly, to a foam laminate for use as a cushion in a snow board, surf board or trunk.

2. Related Prior Art

Foam materials are often used in foam core or soft snow sliders and boards as well as soft body and surf boards since they are light and inexpensive and absorb shocks. As disclosed in U.S. Pat. Nos. 7,160,164, 7,029,349 and 7,430,795 for example, a foam product generally includes a single foam core and one foam skin or more adhered to the foam core. Such a foam skin generally includes a plastic film, a bonding layer and a foam layer. The density of the foam layer is higher than the density of the foam core.

Such foam products are often subjected to impacts during use. For example, while surfing, a surfer exerts considerable impacts on and may compress or dent portions of a surf board corresponding to his or her hands, elbows, knees, feet, head and hips.

Referring now to FIG. 16, a conventional foam body board product is shown. The foam product includes a foam core 90 wrapped in an outer layer or skin 91. A dent A is made in the foam core 90 through the skin 91. The problem related to such dents is particularly serious where the foam core 90 is made of foam polystyrene (“EPS”) or other material that cannot readily return to its original shape.

The present invention is therefore intended to overcome or at least alleviate the problems encountered in prior art.

### SUMMARY OF INVENTION

It is an objective of the present invention to provide a foam laminate comprising a non-foaming plastic sheet and first and second foam layers directly bonded to upper and lower surfaces of the non-foaming plastic sheet, respectively. Alternatively, the first foam layer and the non-foaming plastic sheet also are able to be bonded by a first binding layer; the second foam layer and the non-foaming plastic are able to be bonded by a second binding layer.

The plastic sheet may be made of a polyethylene (“PE”), an oriented polypropylene (“OPP”), a polycarbonate (“PC”) or similar material, including Surlyn® resin which is an ionomeric ethylene copolymer and made by DuPont. The plastic sheet is preferably between about 0.05 mm and 1 mm thick. The first foam layer and the second foam layer may be made of any combination of foam polyethylene (“EPE”) and foam polypropylene (“EPP”). The foam density of the first and second foam layers is preferably between 1.2 pcf and 8 pcf. The thickness of the first and second foam layers is preferably between 1 mm and 8 mm.

The first foam layer, the non-foaming plastic sheet and the second foam layer are made of a same material which is polyethylene, polypropylene or polycarbonate. Alternatively, each of the first foam layer, the non-foaming plastic sheet and the second foam layer is made of different material.

It is another objective of the present invention to provide products advantageously including the foam laminate of the present invention, including but not limited to body boards, surfboards, snow boards, sliders, luggage, trucks, bags, containers, crates, housings. The product further comprises an upper foam skin and a foam core. The foam laminate is located between the upper foam skin and the foam core. An upper surface of the first foam layer of the foam laminate is directly bonded to a lower surface of the upper foam skin. A lower surface of the second foam layer of the foam laminate is directly bonded to an upper surface of the foam core.

The foam laminate may further include a plastic film, a lower foam skin and a plastic plate. The plastic film is directly bonded to an upper surface of the upper foam skin to entirely cover the upper surface of the upper foam skin. The foam skin is preferably made of EPE. An upper surface of the foam skin is directly bonded to a lower surface of the foam core to entirely cover the lower surface of the foam core. The plastic plate generally is directly bonded to a lower surface of the lower foam skin to entirely cover the lower surface of the lower foam skin.

The foam laminate may further comprise a plastic coat layer. The plastic coat is preferably a laminate layer comprising a durable layer such as a Surlyn® resin layer along with a bonding layer and a PE layer. The durable layer such as the Surlyn® resin layer is directly bonded to the PE layer by the bonding layer. The PE layer is directly bonded to the upper surface of the first foam layer. Alternatively, the plastic coat may include a single layer made of PE, OPP, PC or Surlyn® resin.

In comparison with the prior art, the foam laminate of the present invention effectively distributes and cushions impacts, forces and shock. When used as a product or part of a product, the foam laminate provides excellent impact resistance and cushioning to prevent the product from dents, impact and shock.

Other objectives, advantages and features of the present invention will be apparent from the following description referring to the attached drawings.

### BRIEF DESCRIPTION OF DRAWINGS

The present invention will be described via detailed illustration of four embodiments versus the prior art referring to the drawings wherein:

FIG. 1 is a partial, cross-sectional view of a foam laminate in accordance with the first embodiment of the present invention;

FIG. 2 is a partial, side view of a machine and method for making the foam laminate shown in FIG. 1;

FIG. 3 is a partial, cross-sectional view of a foam laminate in accordance with the second embodiment of the present invention;

FIG. 3A is a partial, side view of a machine and method for making the foam laminate shown in FIG. 3;

FIG. 4 is a partial, cross-sectional view of a foam laminate in accordance with the third embodiment of the present invention;

FIG. 5 is a partial, cross-sectional view of a foam laminate in accordance with the forth embodiment of the present invention;

FIG. 6 is a partial, cross-sectional view of a foam laminate in accordance with the fifth embodiment of the present invention;

FIG. 7 is a partial, cross-sectional view of a foam laminate in accordance with the sixth embodiment of the present invention;

FIG. 8 is a partial, cross-sectional view of a foam laminate in accordance with the eighth embodiment of the present invention;

FIG. 9 is a partial, cross-sectional view of a foam laminate in accordance with the eighth embodiment of the present invention;

FIG. 10 is an exploded view of a body board in accordance with the second embodiment of the present invention;

FIG. 11 is a cut-away view of the body board shown in FIG. 10;

FIG. 12 is a partial, cross-sectional view of the body board shown in FIG. 10;

FIG. 13 is a partial, cross-sectional view of a real object of the body board shown in FIG. 10;

FIG. 14 is a perspective view of a luggage product including the foam laminate shown in FIG. 1;

FIG. 15 is a perspective view of a knee cap including the foam laminate shown in FIG. 7;

FIG. 15A is an enlarged cross-sectional drawing of area “A” in FIG. 8; and

FIG. 16 is a cross-sectional view of conventional foam materials of the prior art.

### DETAILED DESCRIPTION OF EMBODIMENTS

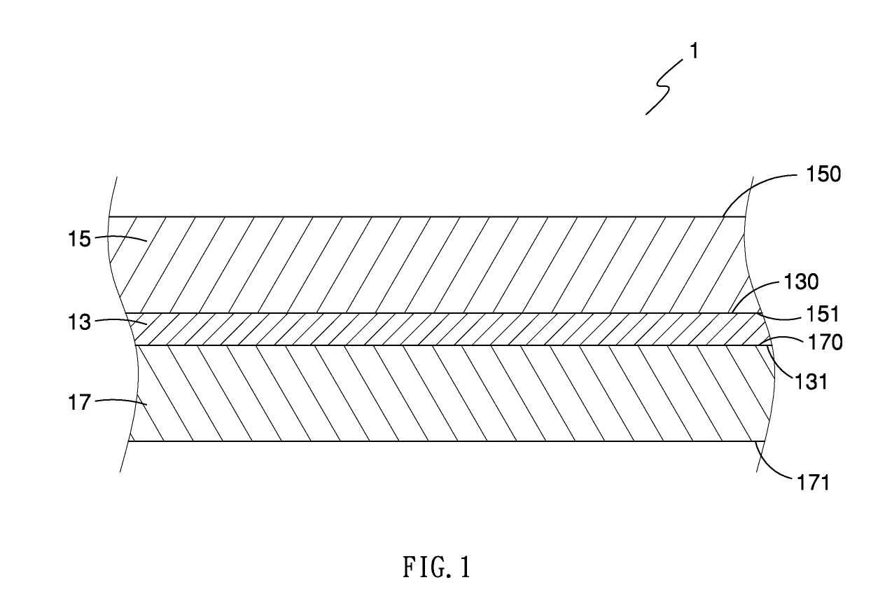

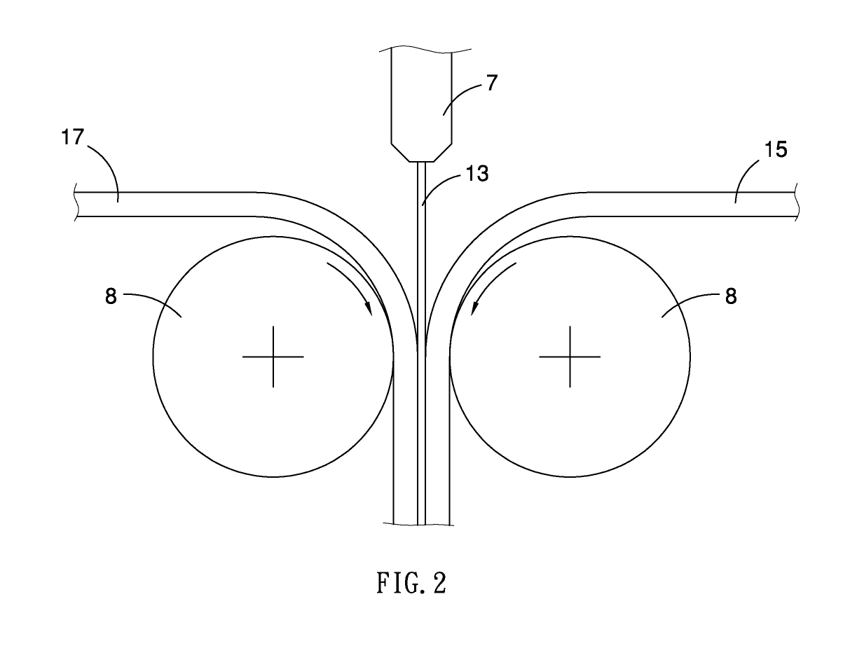

Referring to FIG. 1, a foam laminate material is shown in accordance with a first embodiment of the present invention. The foam laminate 1 includes a plastic sheet 13, a first foam layer 15 and a second foam layer 17. An upper surface 130 of the plastic sheet 13 is directly bonded to the lower surface 151 of the first foam layer 15. A lower surface 131 of the plastic sheet 13 is directly bonded to the upper surface 170 of the second foam layer 17. In specific, the term “directly bonded to” means bonded to without using an adhesive, bonding layer or any other medium. Accordingly, the plastic sheet 13 is bonded to the first foam layer 15 and the second foam layer 17 without adhesive or any other medium.

The plastic sheet 13 may be made high-density, medium density, or low-density polyethylene (“PE”), oriented polypropylene (“OPP”), polycarbonate (“PC”) or a durable material such as Surlyn® resin which is an ionomeric ethylene copolymer and made by DuPont or similar durable material. Alternatively, the plastic sheet 13 may be made from several materials selected from a group comprising PE, OPP, PC or a durable material such as Surlyn® resin made by DuPont or similar durable material. Selecting material, PE, OPP, PC or a durable material such as Surlyn® resin to make the plastic sheet 13 is for the reason that these materials is much tougher than other materials such as ethylene vinyl acetate (EVA). For example, PE, OPP, PC or Surlyn® resin usually is able used to make a shell or a durable container for keeping the original shape of the shell or the durable container when the shell or the durable container bears impacts deformation, a material as EVA is only able to make a soft object, such as a cushion which is for comfortable seating but occurs deformation when the cushion bears impacts. The plastic sheet 13 is preferably between about 0.05 mm and 1 mm thick. Both of the first foam layer 15 and the second foam layer 17 may be made from a material selected from a group comprising foam polyethylene (“EPE”), foam polypropylene (“EPP”) and foam polycarbonate (“PC”). Alternatively, both of the first foam layer 15 and the second foam layer 17 may be made of any combination of foam polyethylene (“EPE”) and foam polypropylene (“EPP”). The foam density of the first foam layer 15 and the second foam layer 17 is preferably between about 1.2 and 8 pounds per cubic foot (“pcf”). The first foam layer 15 and the second foam layer 17 are preferably between about 1 mm and 8 mm thick. It should be noted that the thickness and foam density of the first foam layer 15 and the thickness and foam density of the second foam layer 17 may be identical or different.

Referring now to FIG. 2, it is shown how to bond the plastic sheet 13 to the first foam layer or sheet 15 and the second foam layer or sheet 17 without having to use an adhesive, bonding layer or other medium. Preferably, all of the plastic sheet 13, the first foam layer 15 and the second foam layer 17 are made of a same material and directly bonded together, “directly bonded” means that part of the plastic sheet 13 integrates with part of the first foam layer 15 and part of the second foam layer 17 separately and that the plastic sheet 13 firmly bonds with the first foam layer 15 and the second foam layer 17.

At first, the first foam layer 15 and the second foam layer 17 are directed into a gap between two rollers 8 while plastic sheet 13 in a molten form is extruded from an extruder 7 and directed into a gap between the first foam layer 15 and the second foam layer 17. Then, the rollers 8 are driven to roll and sandwich the molten plastic sheet 13 between the first and the second foam layers 15 and 17.

The plastic sheet 13 is heated, molten and naturally adhesive when it is extruded from the extruder 7, preferably, the plastic sheet 13 extruded from the extruder 7 is non-foaming. Some of the heat of the plastic sheet 13 acts to advantageously heat and melt a portion of the first foam layer 15 and a portion of the second foam layer 17 so that the portions of the first foam layer 15 and the second foam layer 17 are naturally adhered to the plastic sheet 13. Thus, the plastic sheet 13, the first foam layer 15 and the second foam layer 17 are firmly and uniformly bonded to one another after they are rolled by the rollers 8 and cooled. In addition, the plastic sheet 13 becomes tough after it is cooled, and is able to cushion impacts exerted thereon through the first foam layer 15 or the second foam layer 17. Similarly, the foam layers 15 and 17 act to support the plastic sheet 13.

Compared to foam material, the plastic sheet 13 which is non-foaming is able to further resist impacts, namely, the plastic sheet 13 is able to prevent from deformation when the plastic sheet 13 bears impacts. However, foam material is only able to partially absorb impacts but not further resist the impacts, foam material sheet filled with small holes cause that the impacts almost directly pass through foam material and cause the foam material deformation when foam material receives the impacts. Thus, the foam laminate 1 including plastic sheet 13 has the ability to effectively cushion impacts exerted thereon and to prevent from deformation, the ability is not expected and has not been solved in prior art.

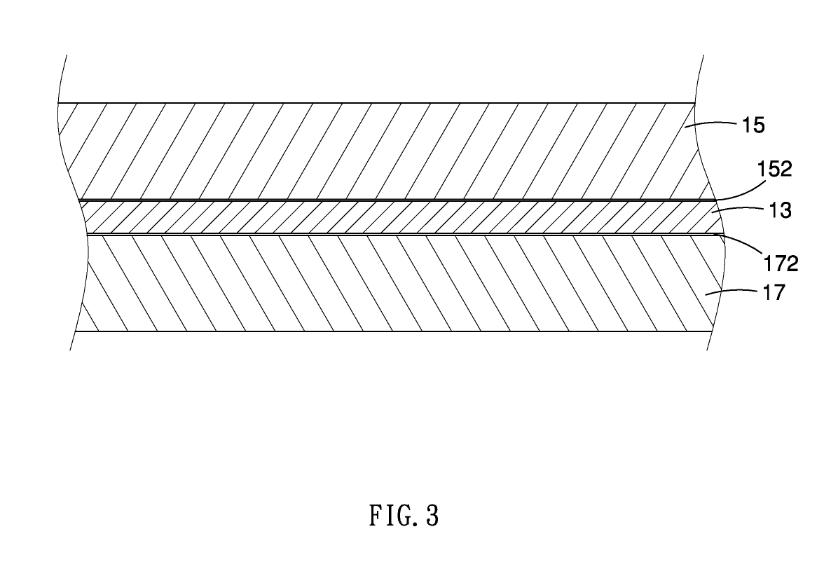

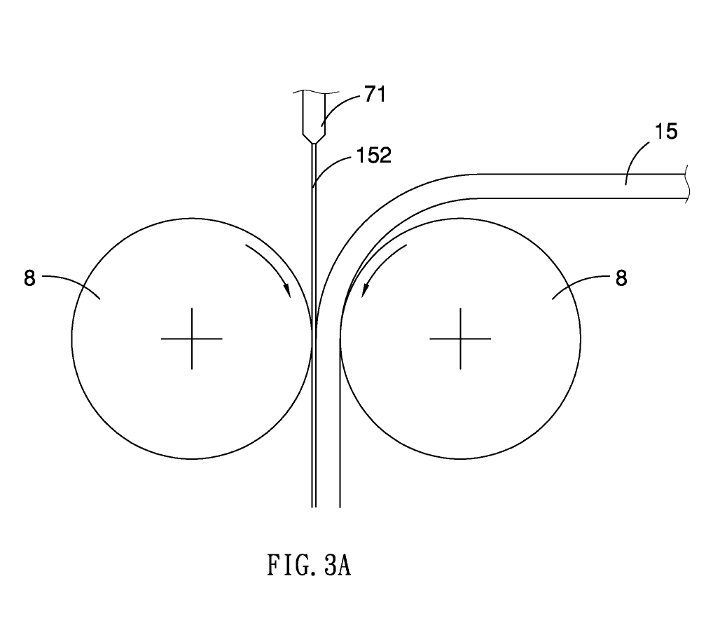

Referring to FIG. 3, a foam laminate material is shown in accordance with a second embodiment of the present invention. Each of the plastic sheet 13, the first foam layer 15 and the second foam layer 17 is made of different material. For example, the first foam layer 15 and the second foam layer 17 are made of polypropylene, the plastic sheet 13 is made of polyethylene; alternatively, the first foam layer 15 and the second foam layer 17 are able to be made of polycarbonate, the plastic sheet 13 is able to be made of polyethylene. The plastic sheet 13 and the first foam layer 15 are bonded together by a first bonding layer 152, and the plastic sheet 13 and the first second layer 17 are bonded together by a second bonding layer 172. The bonding layers 152, 172 are non-foaming material and formed from adhesive agents. The bonding layers 152, 172 are able to be replaced by an adhesive or other medium.

Alternatively, the bonding layers 152, 172 are able to be a multi-property copolymer film which is made of the materials with excellent bonding ability to the plastic sheet 13, the first foam layer 15 and the second foam layer 17, such as a PE/PP copolymer, PE/PC copolymer or an adhesive resin.

For example, as shown in FIG. 3A, first, the bonding layer 152 is extruded from an extruder 71. At this time, the bonding layer 152 is heated, molten and naturally adhesive. The bonding layer 152 is made of polyethylene and polypropylene. Then, the rollers 8 are driven to roll and combine the bonding layer 152 and the first foam layer 15 made of polypropylene together. The bonding layer 172 and the second foam layer 17 made of polypropylene are bonded by the above method(not shown). Finally, the first foam layer 15 coated with the bonding layer 152 and the second foam layer 17 coated with the bonding layer 172 are bonded with the plastic sheet 13 made of polyethylene by the same method as shown in FIG. 2.

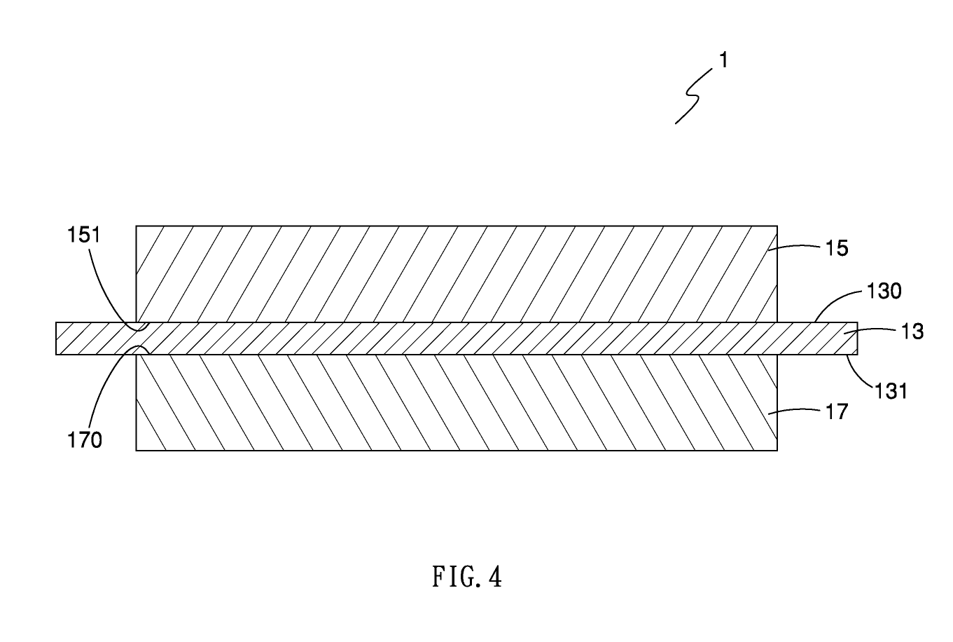

Referring to FIG. 4, a foam laminate material is shown in accordance with a third embodiment of the present invention. Surface area of the upper surface 130 of the plastic sheet 13 may be equal to or larger than surface area of the lower surface 151 of the first foam layer 15, and surface area of the lower surface 131 of the plastic sheet 13 may also be equal to or larger than surface area of the upper surface 170 of the second foam layer 17. This shows that the plastic sheet 13 has a protruding portion protruding over the edges of the first and second foam layers 15 and 17, and the protruding portion of the plastic sheet 13 can be used to combine with other objects.

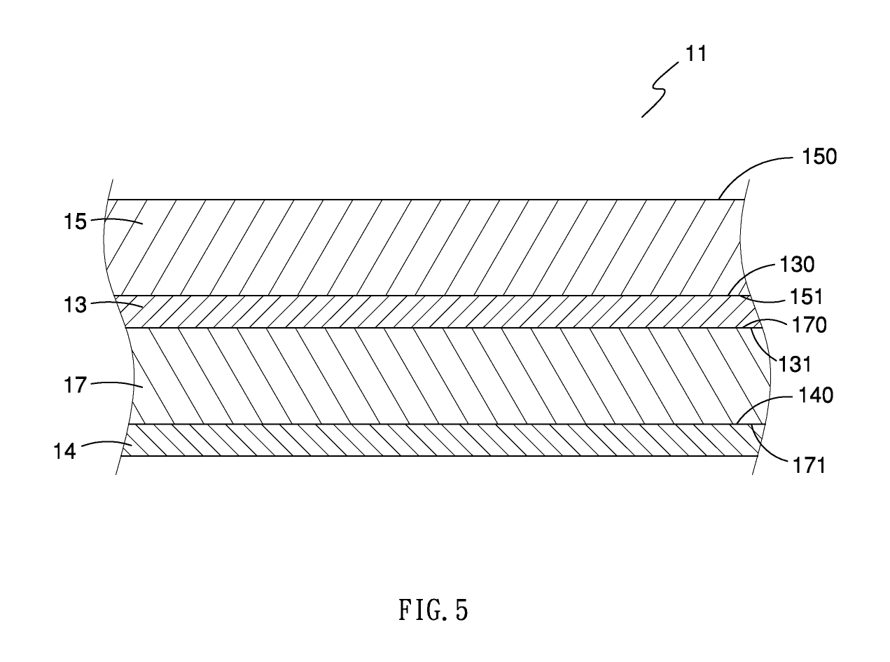

Referring now to FIG. 5, a foam laminate 11 is shown in accordance with a forth embodiment of the present invention. Compared with the foam laminate 1 of the first embodiment shown in FIG. 1, the foam laminate 11 of the second embodiment further comprises a second plastic sheet 14. The second plastic sheet 14 has an upper surface 140 directly bonded to a lower surface 171 of the second foam layer 17. Preferably, the upper surface 140 of the second plastic sheet 14 and the lower surface 171 of the second foam layer 17 are melted together since that the second plastic sheet 14 is bonded to the second foam layer 17 by using the same method which is used to bond the plastic sheet 13 to the first foam layer 15 and the second foam layer 17 as shown in FIG. 2. Specifically, the foam laminate 11 is made by the steps described below. Firstly, the foam laminate 1 of the first embodiment is provided and directed into a gap between two rollers while the second plastic sheet 14 in a molten form is extruded from an extruder and directed into a gap between the foam laminate 1 and one of the two rollers. Then, the two rollers are driven to roll and the molten second plastic sheet 14 is bonded to the second foam layer 17.

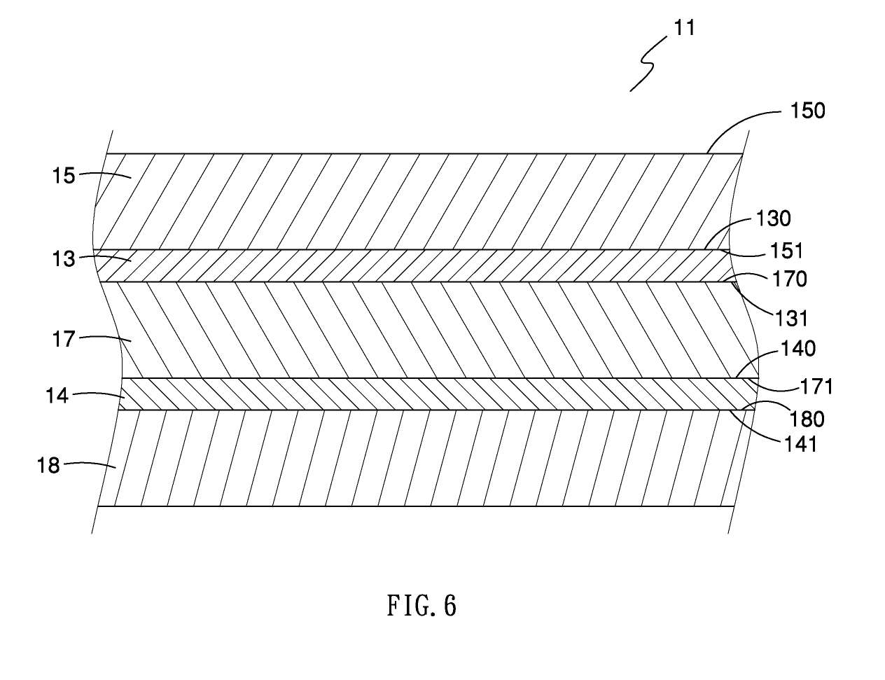

Moreover, as shown in FIG. 6, the foam laminate 11 may further include a fifth foam layer 18 having an upper surface 180 directly bonded to a lower surface 141 of the second plastic sheet 14. Specifically, the upper surface 180 of the third foam layer 18 is melted together with the lower surface 141 of the second plastic sheet 14. Thus, the foam laminate 11 has improved ability to cushion impacts transferring from outside thereof. It should be noted that the foam laminate can further include more plastic sheets and foam sheets laminated in interval sequentially according to different needs.

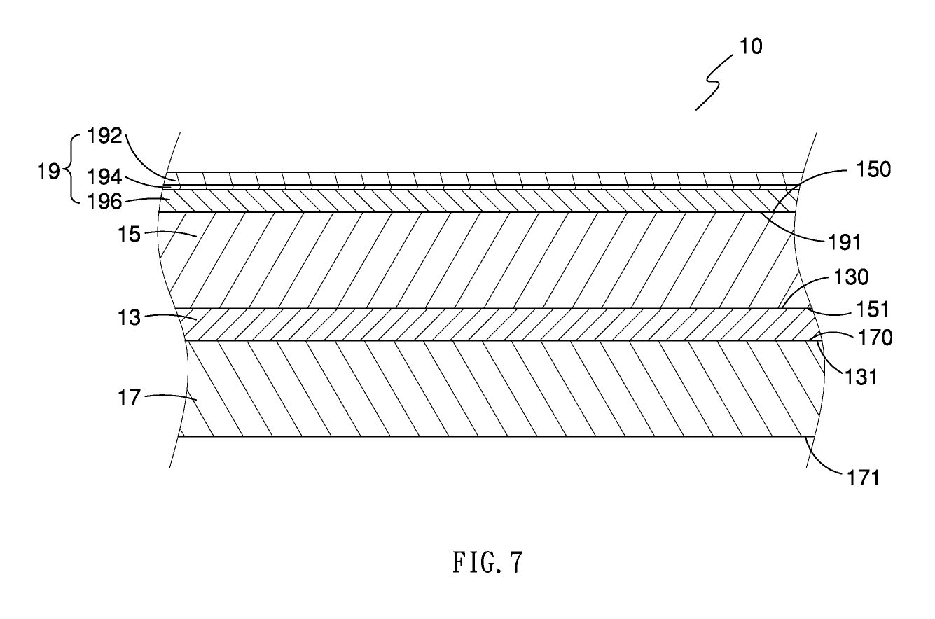

Referring now to FIG. 7, a foam laminate 10 is shown in accordance with a sixth embodiment of the present invention. The foam laminate 10 of this third embodiment further comprises a plastic coat 19 provided on the foam laminate 1 of FIG. 1. The plastic coat 19 may be a multi-layer structure including a plurality of layers which may be made of the same materials or be made of different materials.

The plastic coat 19 is a laminate layer that preferably includes a durable outer layer 192 such as a Surlyn® resin layer along with a bonding layer 194 and a PE layer 196. The durable outer layer 192, the bonding layer 194 and the PE layer 196 all are non-foaming. Alternatively, the plastic coat layer 19 may comprise a durable outer layer 192 along with a plurality of softer inner layer 196. Although the bonding layer 194 is preferable in the instant embodiment, other materials may bond sufficiently without the need for such bonding layer. Moreover, an adhesive may be used in place of such bonding layer 194.

A lower surface of the durable outer layer 192 such as the Surlyn® resin layer is bonded to an upper surface of the bonding layer 194. A lower surface of the bonding layer 194 is bonded to an upper surface of the PE layer 196. That is, the Surlyn® resin layer 192 is preferably bonded to the PE layer 196 using the bonding layer 194. A lower surface 191 of the PE layer 196 is directly bonded to the upper surface 150 of the first foam layer 15. The plastic coat 19 is preferably between about 0.1 and 1 mm thick. When using the Surlyn® resin layer 192 as the outer layer 192, it is preferably about 0.25 mm thick but may be thicker or even thinner based on the product and expected impacts. The bonding layer 194 is preferably about 0.1 mm thick though this may vary depending upon the bonding material and the materials being bonded. The PE layer 196 is preferably about 0.45 mm thick.

Surlyn® resin as the outer layer 192 is presently preferred as it has excellent elasticity, strength and durability so that it is not easily deformed permanently or damaged. Furthermore, Surlyn® resin as the outer layer 192 is wear-resistant and scratch-resistant. Therefore, Surlyn® resin or a material with similar characteristics is a preferred outer layer 192. The PE layer 196 is preferably used to reduce the amount of the Surlyn® resin necessary in the plastic coat 19, while providing the necessary impact resistance and force distribution. When the foam laminate 10 is used to make a product, such as, for example, a snow slider, body board, surfboard, luggage, mat, carrying bag, the second foam layer 17 is preferably located internally or even as an internal side of the product while the durable outer layer 192 of the plastic coat 19 is located on an external side of the product. That is, the plastic coat 19 takes impacts from the exterior directly. On the other hand, the plastic sheet 13 takes the impacts indirectly through the plastic coat 19 and the first foam layer 15. Therefore, the thickness of the plastic coat 19 is preferably greater than or identical to the thickness of the plastic sheet 13. In addition, using a Surlyn® resin as the outer layer 192 of the plastic coat 19 makes the external side of the product look smooth.

The foam laminate 10 may further include a pattern for aesthetic purposes or identification. The pattern may be provided on the upper or lower surface of the outer layer 192 or the upper or lower surface of the PE layer 196.

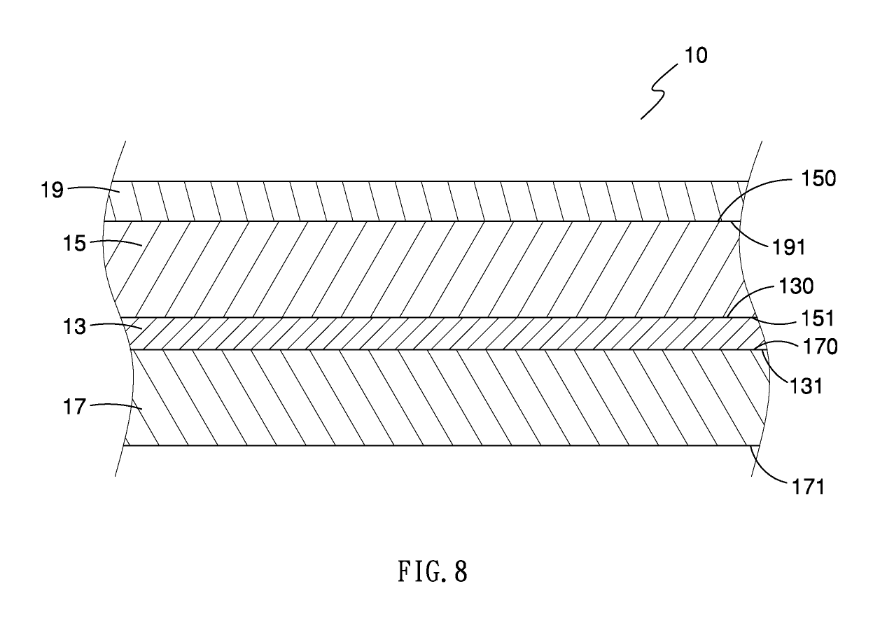

Referring now to FIG. 8, a foam laminate 10 is shown in accordance with a seventh embodiment of the present invention. The seventh embodiment is similar to the sixth embodiment except that the plastic coat 19 solely comprises a single layer. The plastic coat 19 is made of non-foaming material or foam material. The non-foaming material comprises high-density or low-density PE, OPP, PC, Surlyn® resin produced by DuPont, epoxy resin, fiberglass, carbon fiber, polyurethane (PU), thermoplastic polyurethane (TPU), thermoplastic elastomer (TPE), fabric (for example, natural fabric, artificial fabric and nonwoven fabric).

In specific, the plastic coat 19 may be extruded, in a molten form, from the extruder and directed into the gap between the rollers 8 (FIG. 2). The plastic coat 19 and the foam laminate 1 are rolled, pressed and cooled by the rollers 8. Thus, the lower surface 191 of the plastic coat 19 is directly bonded to the upper surface 150 of the first foam layer 15. Thus, the plastic coat 19 is formed and bonded to the foam laminate 1.

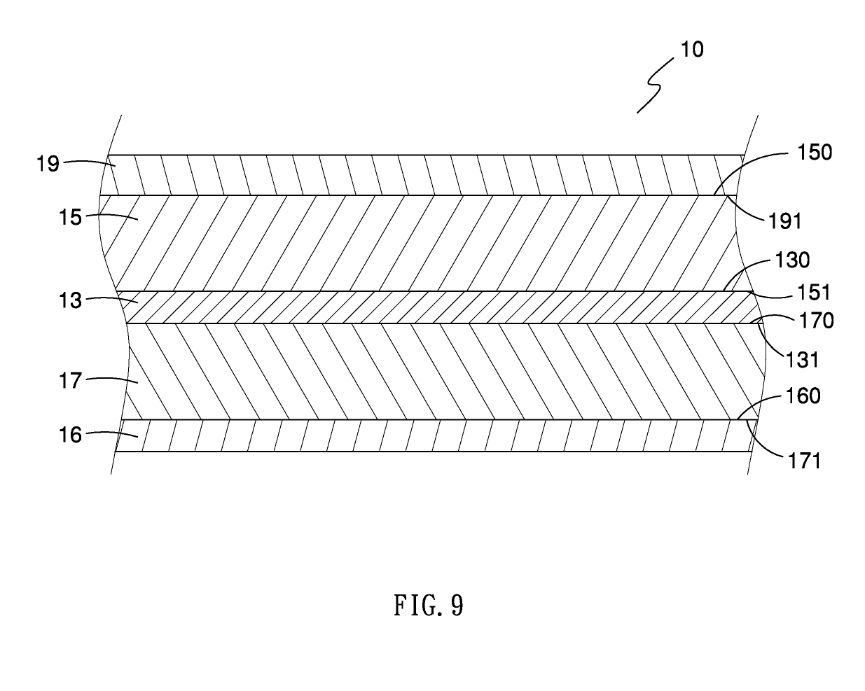

Referring to FIG. 9, a foam laminate 10 is shown in accordance with an eighth embodiment of the present invention. The foam laminate 10 may further include an inner layer 16 which has an upper surface 160 bonded to the lower surface 171 of the second foam sheet 17. Preferably, the inner layer 16 comprises a material selected from the group consisting of epoxy resin, fiberglass, carbon fiber, Surlyn® resin, polyurethane (PU), thermoplastic polyurethane (TPU), thermoplastic elastomer (TPE), fabric (for example, natural fabric, artificial fabric and nonwoven fabric) and foam material. In addition, the outer layer 19 may be a multi-layer structure including a plurality of layers which may be made of the same materials or be made of different materials.

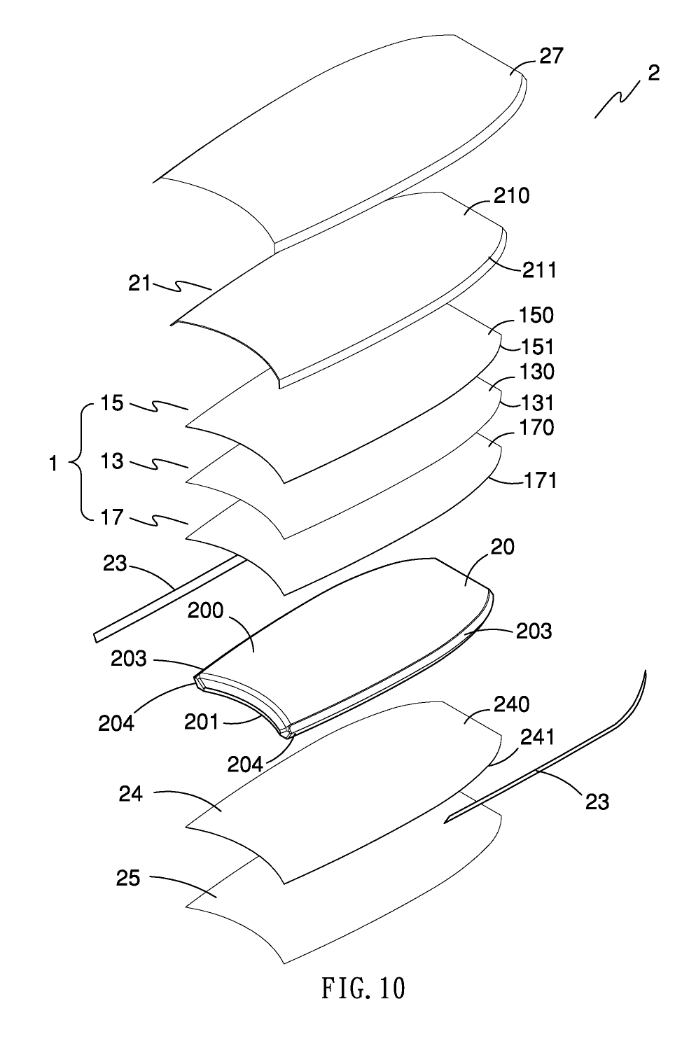

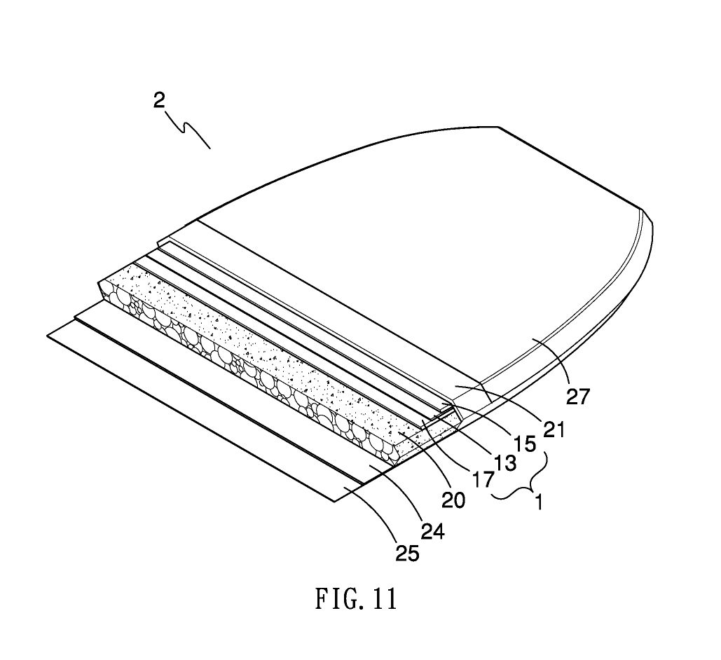

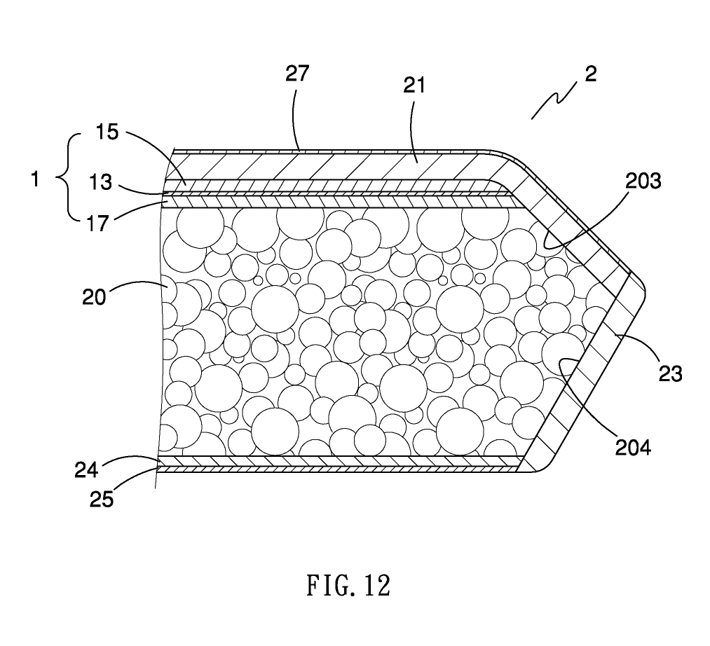

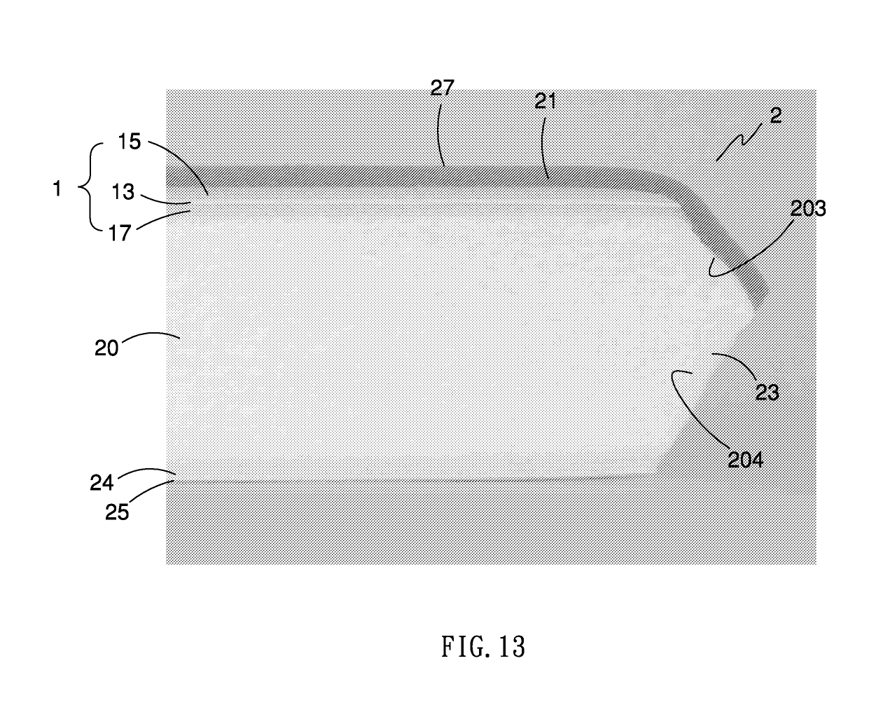

Referring to FIGS. 10 through 13, a riding board 2 is shown in accordance with a ninth embodiment of the present invention. The riding board 2 may be a body board, a slider, a long board, a short board, a knee board, a skim board or any other stand up or lay down type riding product. The riding board 2 includes the foam laminate 1, a foam core 20, an upper foam skin 21, a plastic film 27, two lateral foam skins 23, a lower foam skin 24 and a plastic plate 25.

The foam laminate 1 is sandwiched between the foam core 20 and the upper foam skin 21. The upper surface 150 of the first foam layer 15 of the foam laminate 1 is bonded to a lower surface 211 of the upper foam skin 21. The lower surface 171 of the second foam layer 17 of the foam laminate 1 is bonded to an upper surface 200 of the foam core 20.

The lower surface 211 of the upper foam skin 21 extends beyond the upper surface 200 of the foam core 20 and covers two upper flanks 203. The plastic film 27 covers the entire upper surface 210 of the upper foam skin 21. The foam skins 23 cover two lower flanks 204 of the foam core 20. An upper surface 240 of the lower foam skin 24 is bonded to the lower surface 201 of the foam core 20 and covers the entire lower surface 201 of the foam core 20. The plastic plate 25 is bonded to a lower surface 241 of the lower foam skin 24 and covers the entire lower surface 241 of the lower foam skin 24. The plastic plate 25 may itself be a laminate or a single layer. Preferably, the plastic plate 25 is non-foaming; the plastic plate 25 also is wear and abrasion resistant.

It should be noted that the upper foam skin 21, the foam laminate 1 and the foam core 20 may be bonded to one another by any proper adhesive, heat pressing or similar technique, dependent on the materials used and properties. Similarly, the foam core 20, the lateral foam skins 23, the lower foam skin 24 and the plastic plate 25 may be bonded to one another by any proper adhesive, heat pressing or similar techniques, dependent on what materials are used and their respective properties.

Preferably, the upper foam skin 21 may be made from an EPE. The density of the upper foam skin 21 is preferably between about 4 and 6 pcf but may be somewhat more or less depending on the product or its applications. The thickness of the upper foam skin 21 is preferably between about 4 and 5 mm, but may be somewhat more or less depending on the product or its applications.

As an example, the foam core 20 may be made from a foam polystyrene (“EPS”) for example. Where the foam core 20 is made of an EPS and the second foam layer 17, the foam skins 23 and the lower foam skin 24 are made of an EPE, each of the second foam layer 17, the lateral foam skins 23 and the lower foam skin 24 may be bonded to the foam core 20 by a bonding layer or a layer of an interface material, an adhesive or by heat pressing. The interface material may be a copolymer that can bond EPS to PE.

When impacts, shock or similar forces are exerted on the plastic film 27 of the board 2, the foam laminate 1, which includes the first foam layer 15, the plastic sheet 13 and the second foam layer 17, and particularly the plastic sheet 13, effectively distributes and cushions the forces otherwise impacting the foam core 20 through the upper foam skin 2 Hence, the board 2 is protected and permanent dents prevented.

In addition, the board 2 may further include a pattern for aesthetic purposes or identification. The pattern may be provided on the upper surface 210 of the upper foam skin 21. The pattern may alternatively be provided on or in the plastic film 27. Moreover, the plastic film 27 may be a colored plastic film. Another pattern may be provided on a lower surface of the plastic plate 25 or in the plastic plate 25. The pattern may be provided by heat pressing, branding, screen printing, color printing, transfer or adhesion or other methods as known in the art.

It should be noted that the upper foam skin 21 may be saved from the riding board 2 so that the plastic film 27 covers and is bonded to the upper surface 150 of the first foam layer 15.

The area of the foam laminate 1 is preferably substantially identical to the area of the upper surface 200 of the foam core 20 in the first embodiment. However, the foam laminate 1 may be replaced with a plurality of smaller foam laminates that are made with smaller areas than the upper surface 200 of the foam core 20. Each of the smaller foam laminates may be located in a region of the board 2 (or other product) in which impacts are to be absorbed and cushioned. For example, the regions of the board 2 may be located corresponding to the hands, elbows, knees and head of a rider as well as the lower surface where impacts and similar forces are expected.

In comparison with the prior art, the foam laminate 1, which includes the first foam layer 15, the plastic sheet 13 and the second foam layer 17, provided on or in the board 2, effectively cushions impacts, forces and shock to reduce the effect of those forces exerted on the board 2 and hence protects the board 2 from damage, shock and permanent dents. Similarly, the foam laminate of the present invention may be used to construct products or at least a portion of such products, including but not limited to body boards, surfboards, snow boards, sliders, standing surfaces, toys, luggage, trunks, bags, containers, crates, housings, surface liners, working surfaces, desk tops, resting surfaces, and most any other product that may be subject to impact, shock or compressive forces as well as any items being protected or contained.

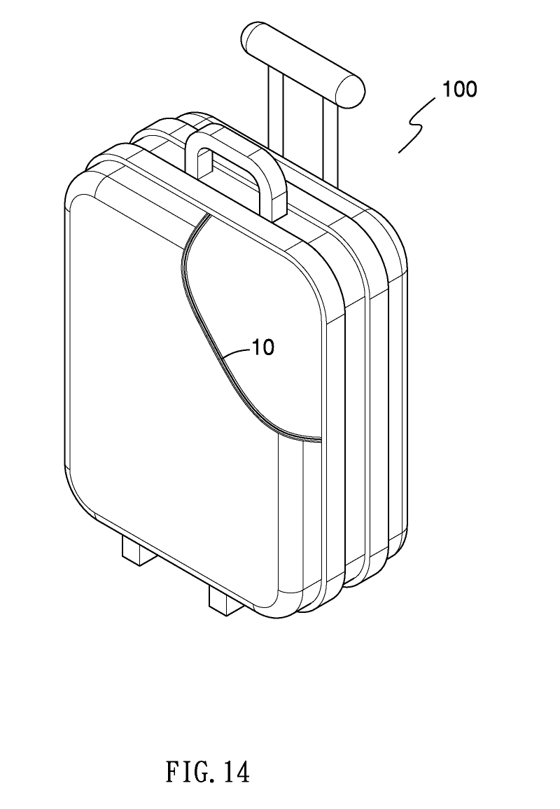

Referring now to FIG. 14 in conjunction with FIG. 7, a trunk 100 or conventional piece of luggage is shown in accordance with a tenth embodiment of the present invention that includes the foam laminate 10 (FIG. 7). The second foam layer 17 is located on an internal side of the truck while the durable layer 192, such as the preferable Surlyn® resin layer of the plastic coat 19 is located on an external side of the product. When the trunk 100 is hit or otherwise impacted, the foam laminate 10 cushions and distributes the impact forces. Therefore, the trunk 100 is protected from permanent dents or fractures. Similarly, the foam laminate may be used on a variety of products subject to impacts, shock and even compressive forces.

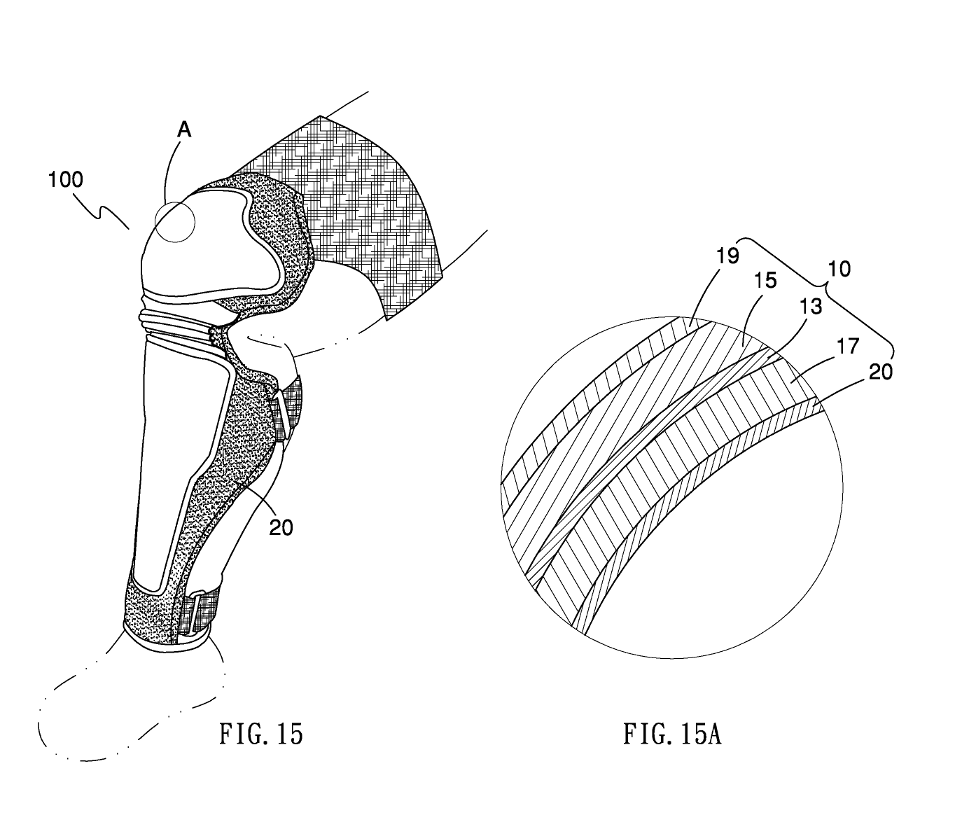

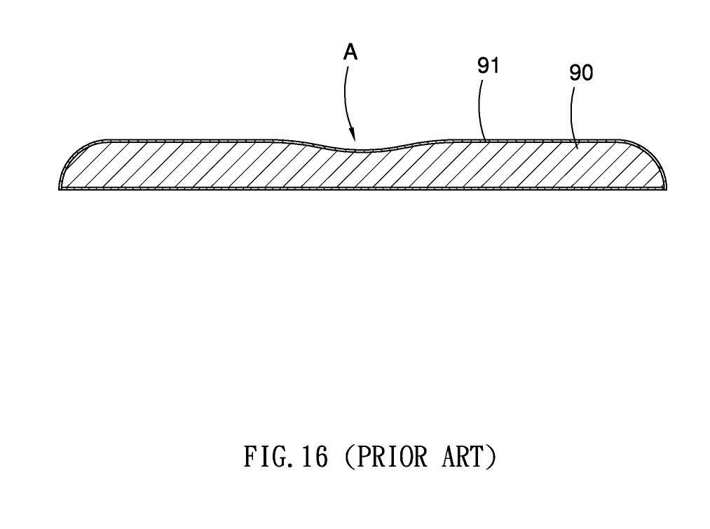

Referring to FIG. 15 is shown in accordance with an eleventh embodiment of the present invention. FIG. 15 is a perspective drawing showing a protective gear. FIG. 15A is an enlarged cross-sectional drawing of area “A” in FIG. 15. As shown in FIG. 15, the protective gear, for example, can be a knee cap 100. The knee cap 100 includes the foam laminate 10 (as shown in FIG. 9). The inner layer 16 of the foam laminate 10, such as a fabric layer, is located on an internal side of the knee cap 100. Turning now to FIG. 15A, the plastic coat 19 of the foam laminate 10, as a protective outer layer, is located on an external side of the knee cap 100. When the knee cap 100 is hit or otherwise impacted, the foam laminate 10 cushions and distributes the impact forces. Therefore, the knee cap 100 is protected from permanent dents or fractures.

It should be noted that the different foam laminates 1, 11, 10 and 100 as abovementioned may be applied to a variety of products, for example, a riding board, a shoe pad, a yoga pad, a helmet, a trunk and so on, which have functions of cushioning and distributing impacts, shock and even compressive forces.

The foregoing description of the embodiments of the invention has been presented for the purposes of illustration and description. It is not intended to be exhaustive or to limit the invention to the precise forms or methods disclosed. Persons skilled in the relevant art can appreciate that many modifications and variations are possible in light of the above teachings.

1. A foam laminate comprising:
a first foam layer;
a non-foaming plastic sheet, having an upper surface bonded to a lower surface of the first foam layer and a thickness between 0.05 mm and 1 mm; and
a second foam layer, having an upper surface bonded to a lower surface of the non-foaming plastic sheet.

2. The foam laminate of claim 1, wherein all of the first foam layer, the non-foaming plastic sheet and the second foam layer are made of a same material.

3. The foam laminate of claim 2, wherein the material is polyethylene, polypropylene or polycarbonate.

4. The foam laminate of claim 1, wherein the first foam layer, the non-foaming plastic sheet and the second foam layer are directly bond together.

5. The foam laminate of claim 1, further comprising a first binding layer and a second binding layer, wherein the first foam layer and the non-foaming plastic sheet are bonded by the first binding layer; the second foam layer and the non-foaming plastic are bonded by the second binding layer; the first foam layer and the second foam layer are made of polypropylene, the non-foaming plastic sheet is made of polyethylene.

6. The foam laminate of claim 1, further comprising a first binding layer and a second binding layer, wherein the first foam layer and the non-foaming plastic sheet are bonded by the first binding layer; the second foam layer and the non-foaming plastic are bonded by the second binding layer; the first foam layer and the second foam layer are made of polycarbonate, the non-foaming plastic sheet is made of polyethylene.

7. The foam laminate of claim 5, wherein the first foam layer and the second foam layer are made of polyethylene, polypropylene or polycarbonate; the non-foaming plastic sheet is made of a material selected from the group consisting of polyethylene, polypropylene, polycarbonate and ionomeric ethylene copolymer.

8. The foam laminate of claim 1, wherein a surface area of the upper surface of the non-foaming plastic sheet is larger than a surface area of the lower surface of the first foam layer; and a surface area of the lower surface of the non-foaming plastic sheet is larger than a surface area of the upper surface of the second foam layer.

9. The foam laminate of claim 1, further comprising a second non-foaming plastic sheet having an upper surface bonded to a lower surface of the second foam layer.

10. The foam laminate of claim 11, further comprising a third foam layer having an upper surface bonded to a lower surface of the second non-foaming plastic sheet.

11. The foam laminate of claim 1, further comprising a plastic coat bonded to the upper surface of the first foam layer.

12. The foam laminate of claim 13, wherein the plastic coat includes an ionomeric ethylene copolymer outer layer, a polyethylene inner layer and a bonding layer therebetween, the ionomeric ethylene copolymer outer layer is bonded to the polyethylene inner layer by the bonding layer, and the polyethylene inner layer is bonded to the upper surface of the first foam layer.

13. The foam laminate of claim 13, wherein the plastic coat comprises a material selected from the group consisting of polyethylene, polypropylene, ionomeric ethylene copolymer, polycarbonate, epoxy resin, fiberglass, carbon fiber, polyurethane, thermoplastic polyurethane, thermoplastic elastomer, fabric and foam material.

14. The foam laminate of claim 13, further comprising an inner layer having an upper surface bonded to the lower surface of the second foam layer.

15. The foam laminate of claim 16, wherein the inner layer comprises a material selected from the group consisting of epoxy resin, fiberglass, carbon fiber, ionomeric ethylene copolymer, polyurethane, thermoplastic polyurethane, thermoplastic elastomer, fabric and foam material.

16. A product comprising:
a foam laminate including:
a non-foaming plastic sheet having an upper surface, a lower surface and a thickness between 0.05 mm and 1 mm;
a first foam layer having an upper surface and a lower surface, wherein the lower surface of the first foam layer is bonded to the upper surface of the non-foaming plastic sheet; and
a second foam layer having an upper surface and a lower surface, wherein the upper surface of the second foam layer is bonded to the lower surface of the non-foaming plastic sheet, and the first and second foam layers are made from a foam polymer;
an upper foam skin bonded to the upper surface of the first foam layer; and
a foam core bonded to the lower surface of the second foam layer.

17. The product of claim 18, further comprising:
a plastic film bonded to an upper surface of the upper foam skin to cover the upper surface of the upper foam skin;
a lower foam skin, bonded to a lower surface of the foam core to cover the lower surface of the foam core; and
a plastic plate bonded to a lower surface of the lower foam skin to cover the lower surface of the lower foam skin.

18. The product of claim 18, wherein the first foam layer and the second foam layer have a foam density between 1.2 pcf and 8 pcf and a thickness between 1 mm and 8 mm.
